(19) United States
(12) Patent Application Publication
(10) Pub. No.: US 2007/0205315 A1
(43) Pub. Date: Sep. 6, 2007

(54) Reciprocating blade food and circumferentially driven blade food preparation appliance

(76) Inventor: James R. Barraclough, Waterbury, CT (US)

Correspondence Address: STEVEN A. GARNER, ESQ.;CONAIR CORPORATION, ONE CUMMINGS POINT ROAD, STAMFORD, CT, 06902, US

(21) Appl. No.: 11/364,996

(22) Filed: Mar. 1, 2006

(51) Int. Cl. A47J 43/046

(52) U.S. Cl. 241/282.1

(57) ABSTRACT

A motor-driven reciprocating blade (32) for cutting food products in one instance, and a circumferentially-driven rotating disc blade (100) for cutting food products in another instance may be contained in a single appliance together or, in another embodiment, separately.

### CROSS-REFERENCE TO RELATED APPLICATIONS

None.

### TECHNICAL FIELD

The present invention relates to food processing appliances and, more particularly, to food processing appliances for multiple purposes having one or more driven blades.

### BACKGROUND OF THE INVENTION

Known food processor appliances typically have a single rotating motor driven shaft to which a round blade disc is mounted, having various features for different types of food cutting operations. Such devices are limited to rotational motion cutting and feeding through a chute mounted above the blade. Center-mounted drive shafts in such devices are required to have high torque and rotational rate outputs to achieve desired cutting.

Another type of known device is referred to as a “mandoline” slicer and is a stationary plate having blades and perforations, similar to a cheese grater, and food is manually reciprocated across the blades. No power-driven mandoline slicers are known to exist.

### OBJECTS OF THE INVENTION

It is an object of the present invention to provide a motorized, electrically powered reciprocating blade food preparation appliance that performs similar tasks as a mandoline slicer and, optionally, has a rotational blade that is mounted and driven in a novel manner to conserve space and make efficient use of a motor.

These objects, as well as others, are achieved by the present invention.

### BRIEF SUMMARY OF THE INVENTION

The present invention achieves the above-mentioned objects by utilizing a motor-driven reciprocating blade for cutting food products in one instance, and a circumferentially-driven rotating disc blade for cutting food products in another instance.

### BRIEF DESCRIPTION OF THE DRAWINGS

FIG. 1 is a schematic, orthogonal view of an appliance according to the present invention.

FIGS. 2 A-2H are, respectively, bottom orthogonal, top orthogonal, first side, second side, front end, rear end, top, and bottom schematic views of a component of the present invention.

FIG. 3 is a schematic, orthogonal view of individual components of the present invention.

FIG. 4 is a schematic, orthogonal view of individual components of the present invention.

FIG. 5A is a schematic, orthogonal view of an appliance according to the present invention.

FIG. 5B is a schematic, partially exploded orthogonal view according to FIG. 5A.

### DESCRIPTION OF THE PREFERRED EMBODIMENTS

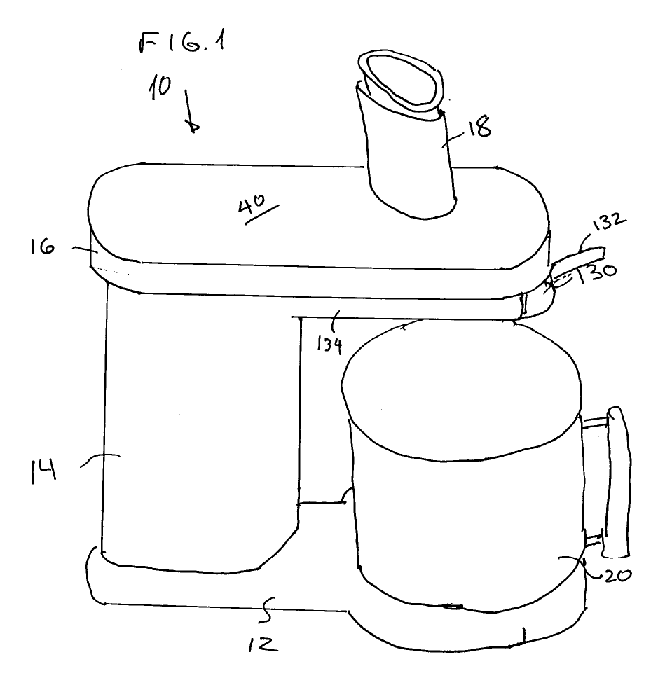

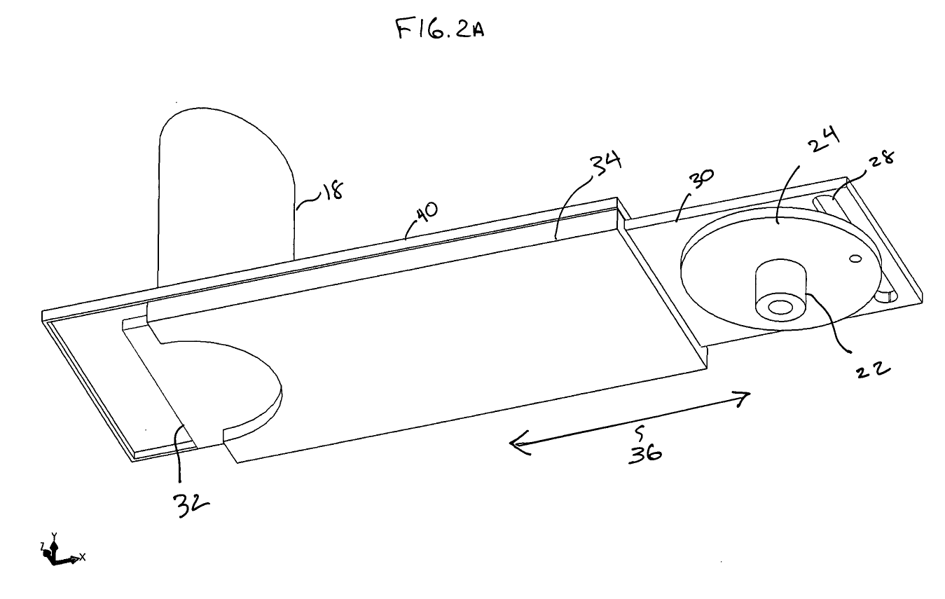

An appliance (10) according to a first embodiment of the present invention is illustrated schematically in FIG. 1. It comprises a base (12), a vertical section (14) housing a conventional electric motor (not shown) therein, an upper section (16), a feed chute (18), and a bowl (20) removably mounted to the base (12).

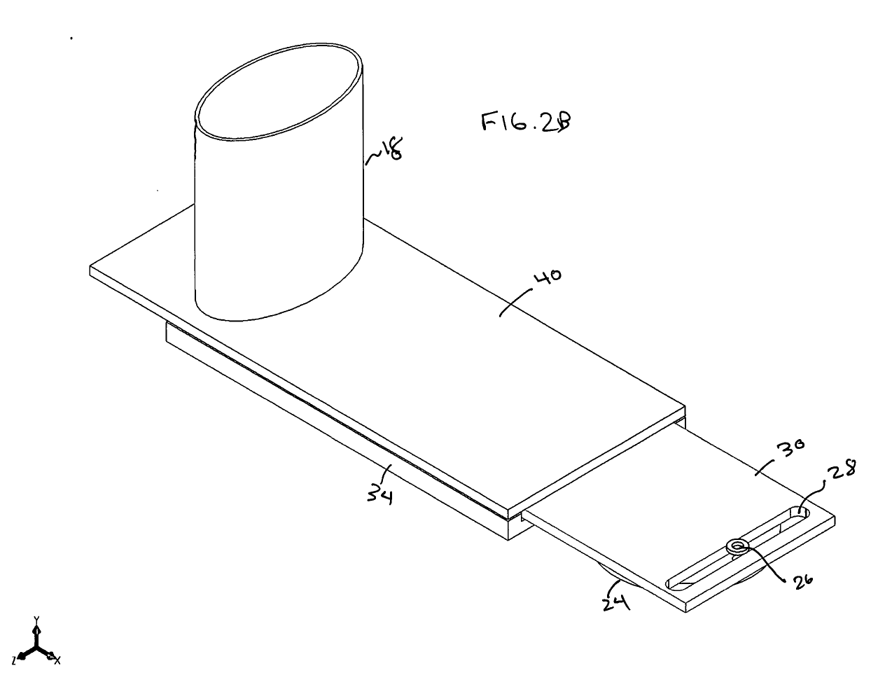

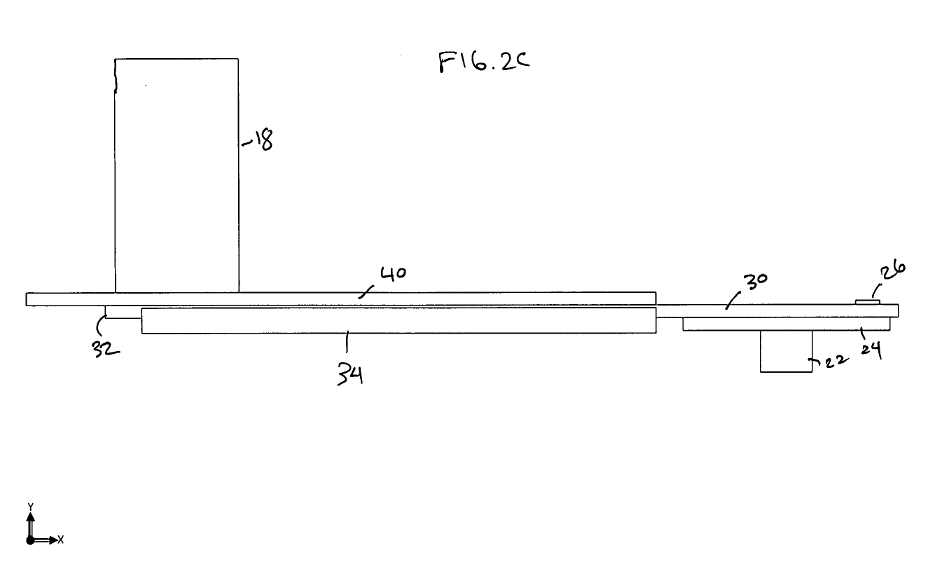

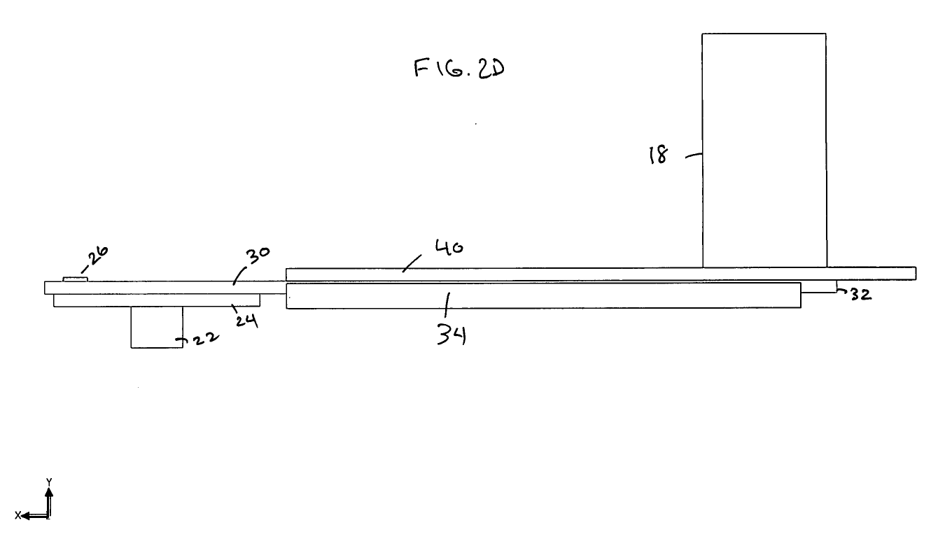

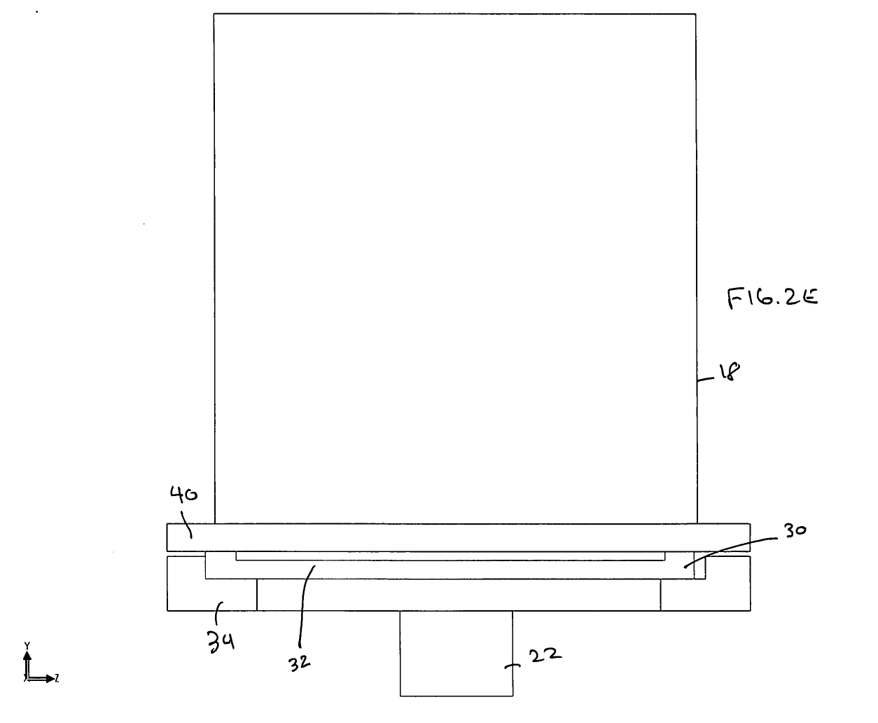

FIGS. 2A-2H illustrate, schematically, the internal components housed in the upper section (16) that comprise a reciprocating, motor driven blade assembly. A driven shaft (22) attached to a driven disc (24) causes a drive pin (26) to rotate about the shaft (22), as the shaft (22) is connected to a rotatable output (not shown) of a conventional electric motor (not shown). The drive pin (26) is received in a drive slot (28) of a blade plate (30). The blade plate (30) has a leading edge (32) that can be sharpened to function as a cutting blade or it can have a blade plate (not shown) attached to it. A receiving sleeve (34) receives the blade plate (30) for reciprocating motion therein. When the electric motor is driven and causes the drive shaft (22) and disc (24) to rotate, the pin (26) travels in a rotational path about the shaft (22). Because the pin (26) is constrained in the slot (28), it is moves the blade plate (30) reciprocally within the receiving sleeve (34) in the directions indicated by the arrow (36) in FIG. 2A. This causes the leading, blade edge (32) to cut food product placed in its path.

Food product is place in the path of the blade edge (32) by being fed through the chute (18). An opening (38) having the shape of the food chute's cross-section and aligned therewith is provided in the top plate (40) of the upper section (16). As food product passes through the opening (38) it is cut by the blade end (32), which is reciprocating while the motor is running, and passes through a cutout section (42) of the receiving sleeve (34). The chopped food product falls into the bowl (20) positioned below it.

FIG. 3 schematically illustrates another aspect of the present invention that is directed to a component that is used in a second embodiment of the present invention. A rotatable food product cutting blade (100) having at least one blade edge (102) formed therein is adapted to be rotatably driven for cutting food product. The blade (100) has a gear ring (104) which surrounds and is attached to then blade, but is shown cut at A-A in FIG. 3 for illustrative purposes. The gear ring (104) has teeth (106) on its circumferential surface for engaging gear teeth (108) on a conventional drive gear (110). The drive gear (110) is mounted for being driven by a conventional electric motor (not shown). As the drive gear (110) is rotated in the direction shown by arrow (112), the blade (100) is driven in the direction shown by arrow (114). The blade (100) is mounted at the center (116) on a stem (118) located on a support plate (120) that can be housed in the upper section (16) of a unit such as that described with respect to FIG. 1. In such an application, an opening (122) on the support plate (120) is located below the chute (18) so that as food product is fed through the chute (18) into the rotatably driven blade (100), chopped food product passes through the opening (122) and falls into the bowl (20).

Preferably, the stem (118) is spring biased for motion in the directions indicated by arrow (124). A complementary stem (126) can be positioned on a surface (128) directly above the support plate (120) and similarly biased. This enables one to insert or remove the blade (100) into and out of operating position by laterally moving the blade parallel to and directly above the support plate (120) for convenient use. For example, the opening (130) of the upper section (16) shown in FIG. 1 can be an entry and removal port for a blade (100) according to this aspect of the invention. The motor and drive system for driving the drive gear (110) are housed in the vertical section (14). A hinged door (132) can be opened and closed to access the opening (130).

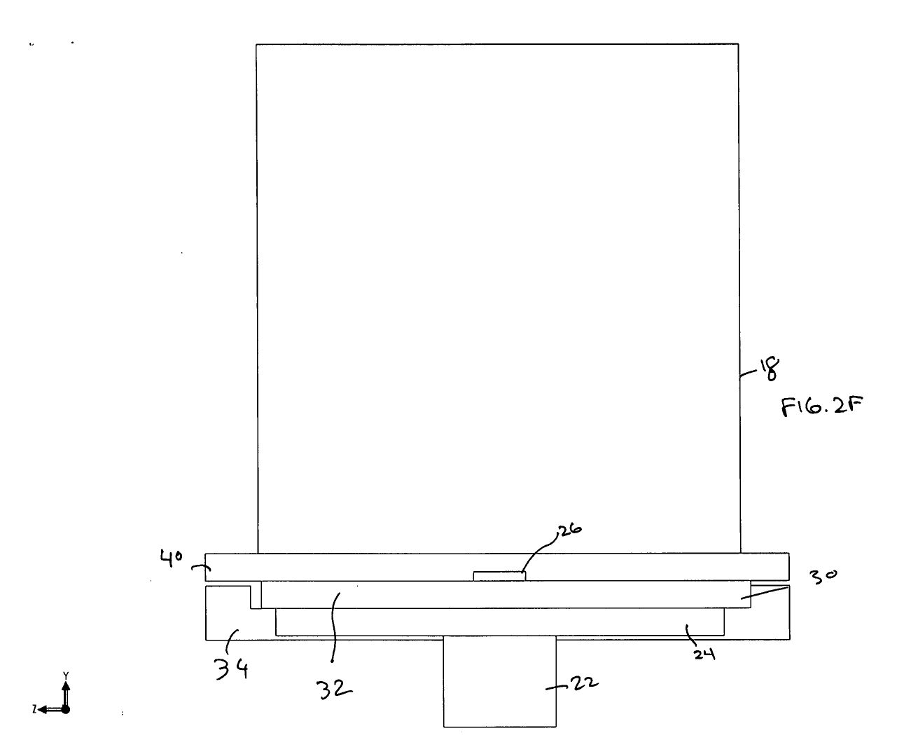

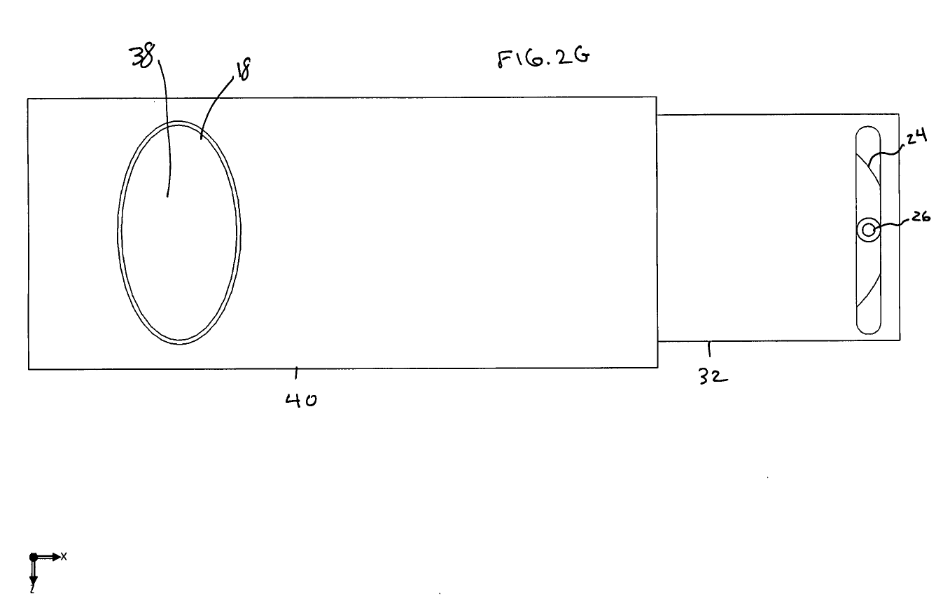

In one embodiment of the invention, both the reciprocating assembly described with respect to FIGS. 2A-2H and the circumferentially-driven blade assembly described with respect to FIGS. 3-4 can be contained in a single unit for versatility. They can be housed, respectively, as follows: the reciprocating blade assembly in the upper section (16); and the circumferentially-driven blade assembly in the lower portion (134) of the upper section (16).

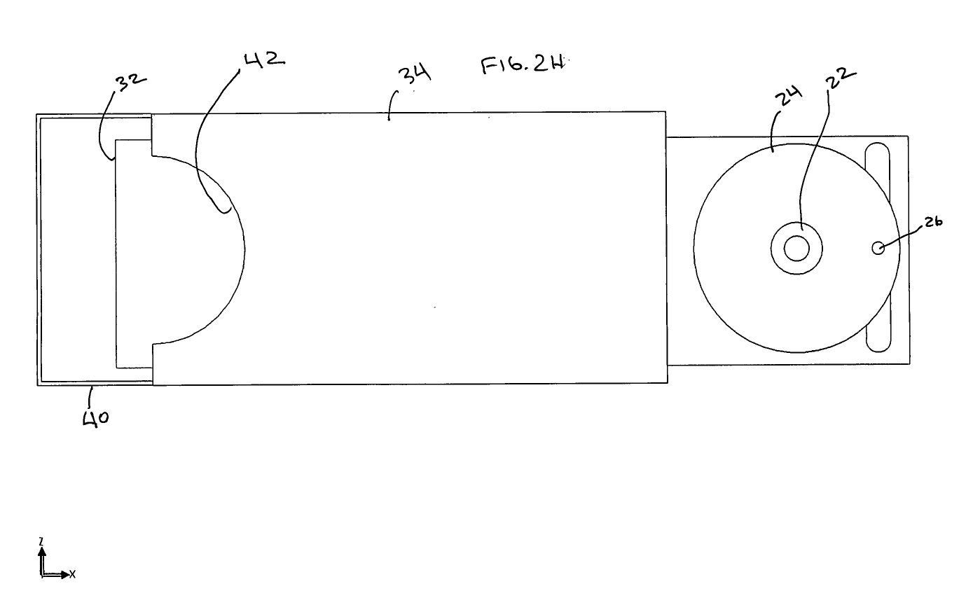

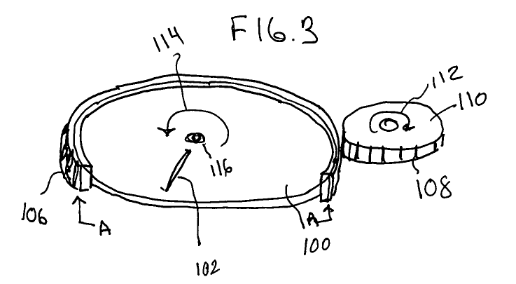

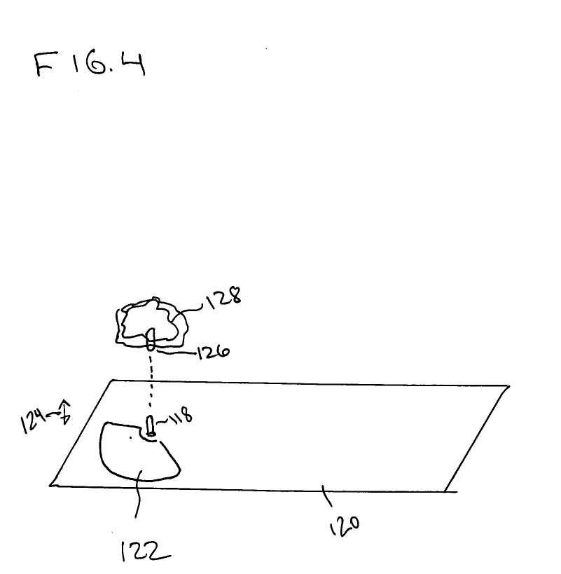

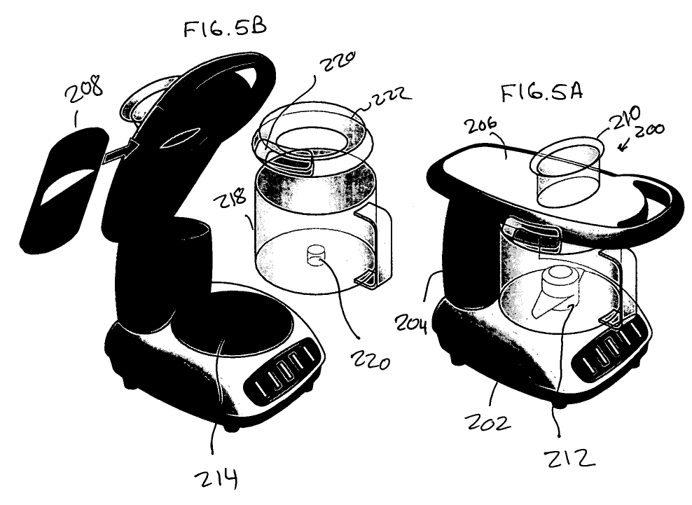

Another embodiment of the present invention is shown schematically in FIGS. 5A-5B. A food processing appliance (200) comprises a base (202), a vertical section (204), an upper section (206), and a feed chute (210). The base (202) has a drive shaft (214) of a conventional type that is driven by a conventional electric motor (not shown) housed internally. A rotating chopper blade assembly (212) mounts on the shaft (214) after the bowl (218) is positioned over it. The bowl (218) has a raised opening (220) that is positioned around the shaft (214) and that receives the blade assembly (212) thereon for rotating movement. The upper section (206) may house a reciprocating blade assembly (208) that is essentially similar in operation, form and function as that described in the above embodiment. Food product may be fed through the chute (210) for cutting by the reciprocating blade assembly (208). Food product may be fed through an opening (220) in a bowl ring (222) mounted atop the bowl (218) for cutting by the chopper blade assembly (212).

In another embodiment, a unit as described with respect to FIG. 1 can have only the reciprocating blade assembly, but not the circumferentially-driven blade assembly.

In another embodiment, a unit as described with respect to FIG. 1 can fave only the circumferentially-driven blade assembly, but not the reciprocating blade assembly.

While the preferred embodiments of the present invention have been herein described, various modification may be made without departing from the scope of the present invention.

What is claimed is:

1) A food appliance comprising
a base;
a housing;
an electric motor mounted in said housing;
a drive output connected to said motor;
a first blade adapted for reciprocating motion within said housing;
a first drive assembly driven by said drive output for imparting reciprocating motion to first said blade; and
a food product feed assembly for feeding food product to said blade while it is reciprocating causing said food product to be cut.

2) An appliance according to claim 1, further comprising
a second blade adapted for rotational motion; and
a second drive assembly driven by said drive output for imparting rotational motion to said second blade in order to cut said food product.

3) An appliance according to claim 2, further comprising
a gear surface attached to an outer circumferential surface of said second blade;
at least one driven gear driven by said drive output and engaging said gear surface in order to impart rotational motion to said second blade.

4) An appliance according to claim 1, further comprising
a third blade adapted for rotational motion; and
a third drive assembly driven by said drive output for imparting rotational motion to said third blade in order to cut food product, wherein said third blade is mounted to said base.

5) An appliance according to claim 4, further comprising
a bowl having an opening in its bottom surface adapted to receive a portion of said third drive assembly therethrough when said bowl is positioned on said base and when said third blade is operatively connected to said third drive assembly.
